(19) United States
(12) Patent Application Publication
(10) Pub. No.: US 2025/0196941 A1
(43) Pub. Date: Jun. 19, 2025

(54) TRUCK CAP

(71) Applicant: Adrian Steel Company, Adrian, MI (US)

(72) Inventors: Mark Anthoney Henry, JR., Adrian, MI (US); Robert Michael Butcher, Saint Charles, MI (US); Joshua Michael Gerez, Tecumseh, MI (US); Joshua James Parker, Adrian, MI (US); Kyle Jeffery Lakatos, Clayton, MI (US); Joshua Merle Rogers, Manitou Beach, MI (US)

(21) Appl. No.: 18/974,947

(22) Filed: Dec. 10, 2024

Related U.S. Application Data
(60) Provisional application No. 63/611,549, filed on Dec. 18, 2023.

(51) Int. Cl. B62D 33/04

(52) U.S. Cl. CPC B62D 33/04

(57) ABSTRACT

A truck cap may have a sub-frame. The sub-frame may have at least one side bracket. The side bracket may have an angled upright portion and an upper flange. A side module may be located between two side brackets. The side module may have channel members that receive a portion of a side door therein.

### FIELD

A truck cap is provided that may be used with a vehicle, such as a pickup truck.

### BACKGROUND

Truck caps are devices that may at least partially enclose a vehicle, such as the cargo bed of a pickup truck. In most cases, the caps comprise two sides that may rest on the side walls of the bed and extend upwardly therefrom. A roof may extend between the two sides. A front panel and a rear panel may close the front and rear areas of the cap. Doors may be located in the sides and/or rear to access the interior of the cap from the outside.

Some prior art cap designs have a substantially one-piece construction. It has been found that these designs are disadvantageous as they take up large amounts of storage space in warehouses, they are difficult to ship and install because of their size, and if the cap is damaged, or in need of a modification, the one-piece design makes both of these difficult endeavors.

In view of the disadvantages associated with the prior art, it would be advantageous for a cap to have a design that is easy and cost effective to store, ship and install. It would also be advantageous for a cap to be easily modified during construction or afterward to accommodate consumer preferences and/or for repair or replacement.

### SUMMARY

In one aspect, a truck cap may have a sub-frame comprising a front side bracket and a rear side bracket. Each of the brackets may have an angled upright portion and an upper flange attached to an upper end portion of the upright portion. A sill may extend between the brackets. A side module may be connected to the sub-frame, the side module may have a forward side channel member, a rear side channel member, an upper channel member and a lower channel member. Each of the channel members may define a continuous channel extending about the side module. The channel may be bounded by a first wall and a second wall where a portion of the first wall may be cantilevered over the channel.

In another aspect the truck cap may have a sub-frame having a front side bracket and a rear side bracket. Each of the brackets may have an angled upright side portion and an upper flange top portion attached to an end portion of the upright portion. A side module may be attached to and located between the front side bracket and the rear side bracket. A front module may be located on a forward side of the front side bracket and a rear module may be located on a rear side of the rear side bracket.

In another aspect, the truck cap may have a sub-frame comprising a front side bracket, a rear side bracket, and a roof side member and a sill extending between the front and rear side brackets. A side module may have an upper channel member attached to the roof side member, a forward side channel member attached to the front side bracket, a rear side channel member attached to the rear side bracket, and a lower channel member attached to the sill. The side module may have a continuous channel extending through the upper channel member, the forward and rear side channel members and the lower channel member.

In another aspect, the truck cap may have a frame member comprising a roof portion connected to a side portion. A side channel member may be attached to the side portion. The side channel member may have a continuous channel therein. A rear side channel member may be attached to the side portion. The rear side channel member may have a continuous channel therein. The frame member may be located between the side channel member and the rear side channel member.

In another aspect, the truck cap may have a sub-frame, comprising a rear side bracket comprising a roof portion connected to a side portion. A rear arch member may have a center section located between two legs, wherein one of the legs is connected to the side bracket. A side module may be supported by the rear side bracket. A partially overlapped channel extends about the side module, wherein a side panel door selectively fits in the channel. A rear module may be supported by the rear arch member and extending generally transverse the side module. A partially overlapped channel extends in part about the rear module. A rear panel door may selectively fit in the channel.

### BRIEF DESCRIPTION OF THE DRAWINGS

The above, as well as other advantages, will become readily apparent to those skilled in the art from the following detailed description when considered in the light of the accompanying drawings in which:

FIG. 1 is rear perspective view of one embodiment of a truck cap;

FIG. 2 is a front perspective view of the truck cap of FIG. 1;

FIG. 3 is a top view of the truck cap of FIG. 1;

FIG. 4 is an underside view of the truck cap of FIG. 1;

FIG. 5 is a rear perspective view of the truck cap of FIG. 1;

FIG. 6 is a lower perspective view of the truck cap of FIG. 1;

FIG. 7 is a lower side perspective view of the truck cap of FIG. 1;

FIG. 8 is a lower inside perspective view of the truck cap of FIG. 1;

FIG. 9 is an exploded perspective side view of the truck cap of FIG. 1;

FIG. 10 is an exploded rear side perspective view of the truck cap of FIG. 1;

FIG. 11 is an exploded bottom side perspective view of the truck cap of FIG. 1;

FIG. 12 is an exploded bottom side perspective view of the truck cap of FIG. 1;

FIG. 13 is part of an exploded side perspective view of the truck cap of FIG. 1;

FIG. 14 is part of an exploded side view of the truck cap of FIG. 1;

FIG. 15 is part of an exploded front view of the truck cap of FIG. 1;

FIG. 16 is part of an exploded side view of the truck cap of FIG. 1;

FIG. 17 is part of an exploded side view of the truck cap of FIG. 1;

FIG. 18 is part of an exploded side view of the truck cap of FIG. 1;

FIG. 19 is part of an exploded view of the truck cap of FIG. 1;

FIG. 20 is part of an exploded bottom view of the truck cap of FIG. 1;

FIG. 21 is part of an exploded top view of the truck cap of FIG. 1;

FIG. 22 is part of an exploded bottom view of the truck cap of FIG. 1;

FIG. 23 is part of an exploded side view of the truck cap of FIG. 1; and

FIG. 24 is part of an exploded side view of the truck cap of FIG. 1.

### DETAILED DESCRIPTION

It is to be understood that the device may assume various alternative orientations and step sequences, except where expressly specified to the contrary. It is also to be understood that the specific devices and processes illustrated in the attached drawings, and described in the following specification are simply exemplary embodiments of the in the appended claims. Hence, specific dimensions, directions or other physical characteristics relating to the embodiments disclosed are not to be considered as limiting, unless the claims expressly state otherwise.

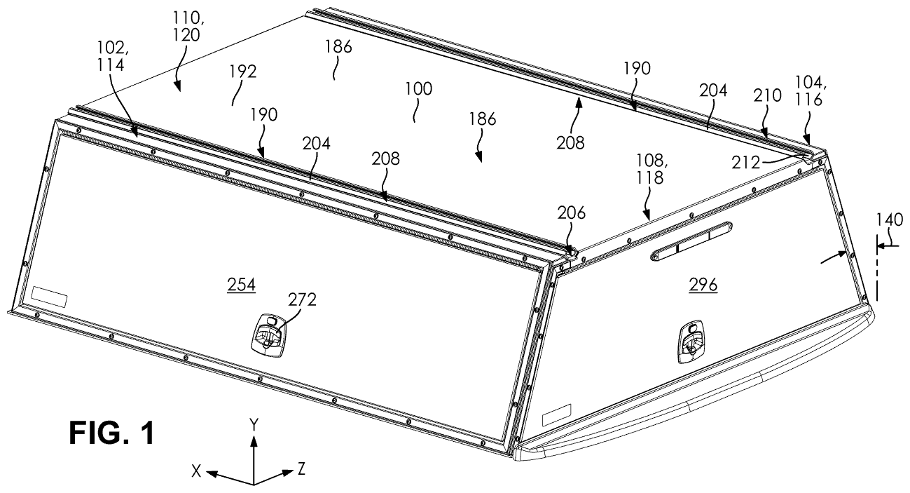

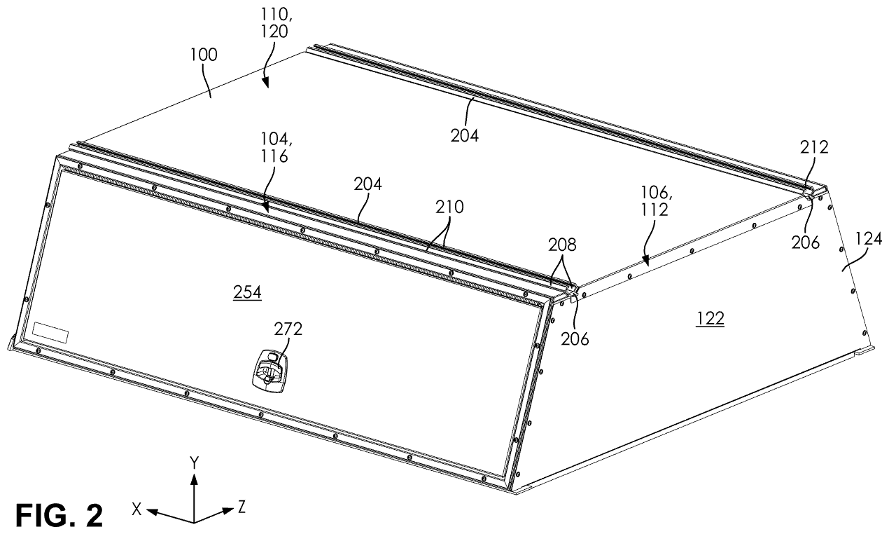

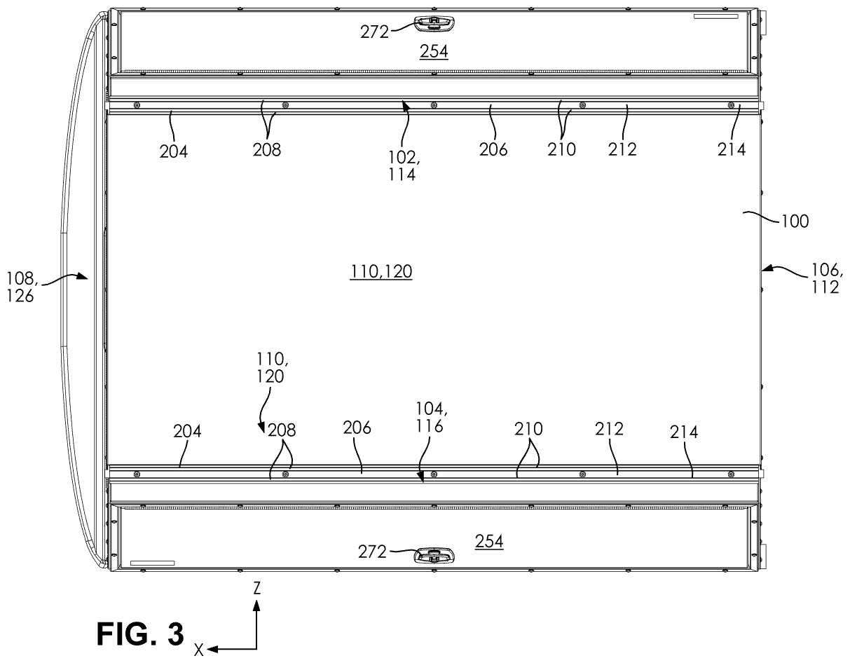

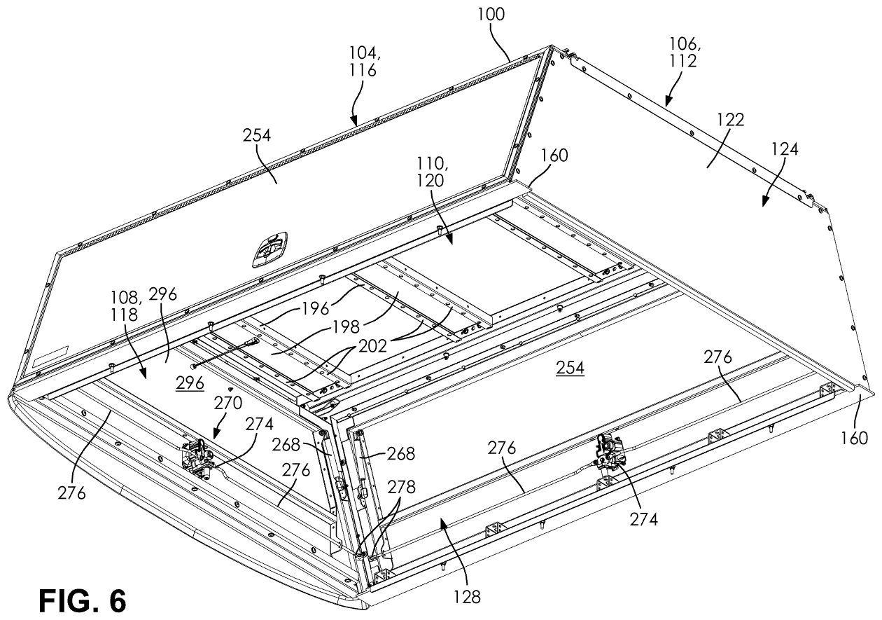

Turning now to FIG. 1-8, one embodiment of a truck cap 100 is depicted. An X-Y-Z axis of a Cartesian coordinate system is depicted in FIG. 1. For example, the X-direction may be such as a longitudinal direction associated with the cap 100, which may also be associated with the vehicle (not shown) on which the cap 100 is located. The longitudinal direction may extend from the front to the rear of the vehicle. In some cases, the X-direction may be such as a forward and a reverse direction of travel associated with the vehicle. The Y-direction may be such as generally transverse the X-direction and may associated with the vertical direction of the cap 100 and/or vehicle. The vertical direction may be such as extending from the bottom of the vehicle to the top of the vehicle. The Z-direction may be transverse the X and Y directions. The Z-direction may be extending from one side of the vehicle toward the other side of the vehicle, such as from a passenger side to a driver side.

The truck cap 100 may have a first side portion 102 and an opposite second side portion 104, as well as a front portion 106 and an opposite rear portion 108. A top portion 110 may extend between the side portions 102, 104 and the front and rear portions 106, 108. Each portion 102, 104, 106, 108, 110 may comprise its own module. Thus, the cap 100 may have a front module 112, two side modules 114, 116, a rear module 118 and a top module 120. Each module 112, 114, 116, 118, 120 may be altered or replaced without substantially affecting the other modules. In this case, substantially may mean that the modules themselves may be structurally modified. Instead, it may be that one module is mechanically release from the other. For example, mechanical fasteners that may connect the modules to other structures of the cap 100 may be removed and reattached to that the modules may be swapped. The modules 112, 114, 116, 118, 120 may be standardized units or sections for ease of construction or flexible arrangement. The modules 112, 114, 116, 118, 120 may be separate parts that when combined form a complete cap 100. In some cases, not all the modules 112, 114, 116, 118, 120 may be need for a cap 100. For examples, the cab of the vehicle may remove the need for the front module 112.

In one embodiment, the front module 112 may be comprised of a panel 122. The panel 122 may have a generally planar forward side 124 and a generally planar rear side 126 separated by a substantially constant thickness. The panel 122 may also be substantially planar in the X direction. The panel 122 may be substantially continuous and uninterrupted so as to enclose an interior portion 128 of the cap 100. In another embodiment, the panel 122 may have various shapes, sizes, thickness and/or be interrupted by other feature or components. In some cases, the front panel 122 is mechanically attached to the sides 114, 116 and/or top portions 120 such as through with mechanical fasteners for easy attachment and/or removal.

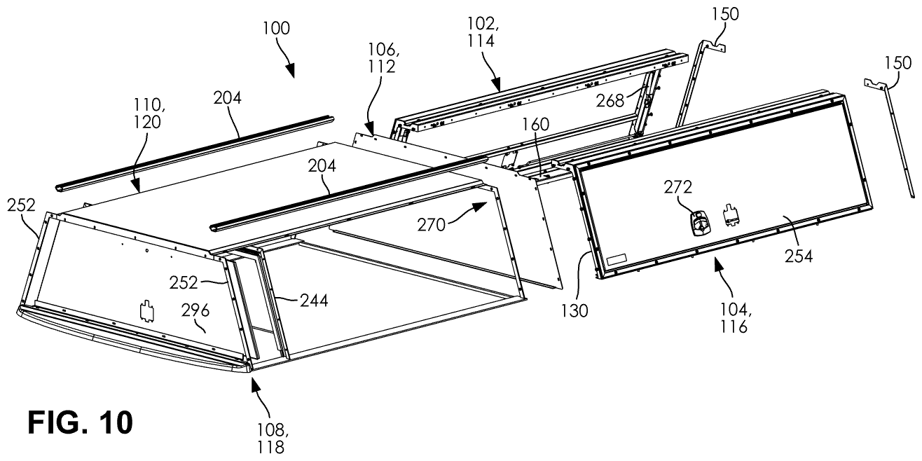

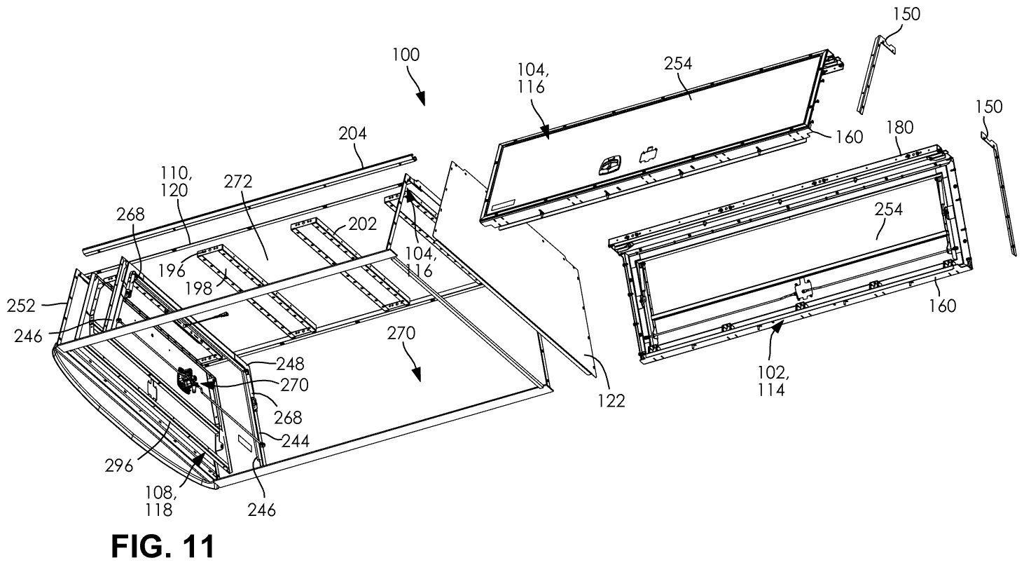

At least one of the modules 112, 114, 116, 118, 120 may be comprised of a sub-frame comprised of a plurality of components. In the case of a side module 114, 116, one component of the sub-frame may be a rear side bracket 130, as may be seen in FIGS. 10, 11 and 13. The rear side bracket 130 may have a side portion 132 and an upper flange 134. The upper flange 134 may be connected to an upper portion 136 of the side portion 132. In some embodiments, an obtuse angle 138 may be formed between the side portion 132 and the upper flange 134. When oriented in the cap 100, the side portion 132 and the upper flange 134 may generally form an upside-down L-shape. The rear side bracket 130 may be unitary, one-piece and integrally formed of metal, but other materials with a similar strength, rigidity and other related characteristics may be used. Similarly, the cap 100 and its other components may be formed of metal.

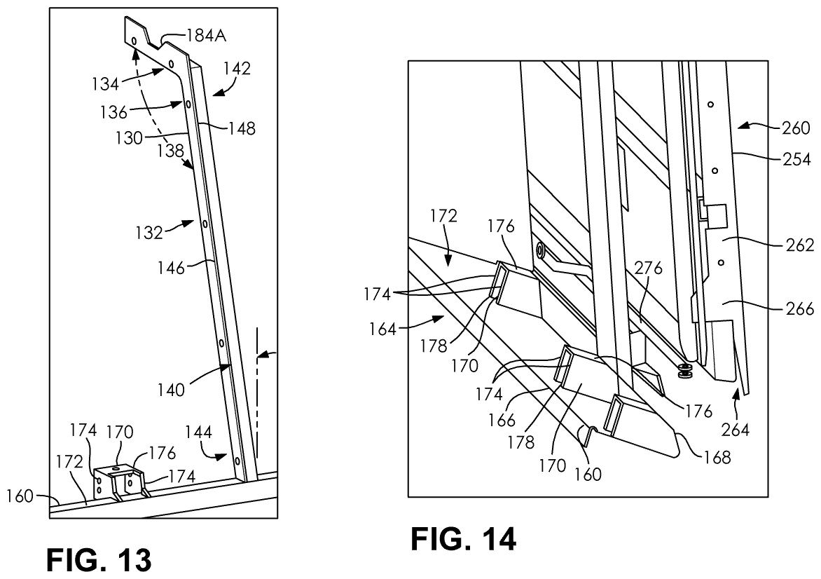

The side portion 132 may extend at an angle in the installed condition. The angle may be such as an acute angle 140 measured from the Y-axis. In other words, the side portion 132 may have an upper, inner portion 142 that extends into the Z-axis to a greater extent than a lower, outer end portion 144 of the side portion 132 extends into the Z-axis. The acute angle 140 of the rear side bracket 130 lends to a general trapezoidal shape of the cap 100, as may be appreciated from FIGS. 1 and 13.

By trapezoidal it may be that the two side portions 102, 104 may not be parallel one another or the top portion 110 but instead extend downwardly from the top portion 110 generally at the same angle as one another. A trapezoid typically has a bottom portion and the thickness of the side portions 102, 104 may comprise the bottom portion of the trapezoid. Such a shape may be such as an isosceles trapezoid. While one shape is mentioned above, other shapes may be used without limitation.

As may be best seen in FIG. 13, the side portion 132 of the rear side bracket 130 may be comprised of first and second flanges 146, 148. The flanges 146, 148 may be connected together generally along their length. The flanges 146, 148 may extend approximately 90 degrees from one another. Thus, in some cases, the second flange 148 may extend away from the first flange 146 in the direction of the X-direction and the first flange 146 may extend in the direction of the Y-direction. The upper flange 134 may extend from the first flange 146. In some embodiments, the upper flange 134 may be coplanar with the first flange 146 in the X-direction. The second flange 148 may terminate before it reaches the first flange 146.

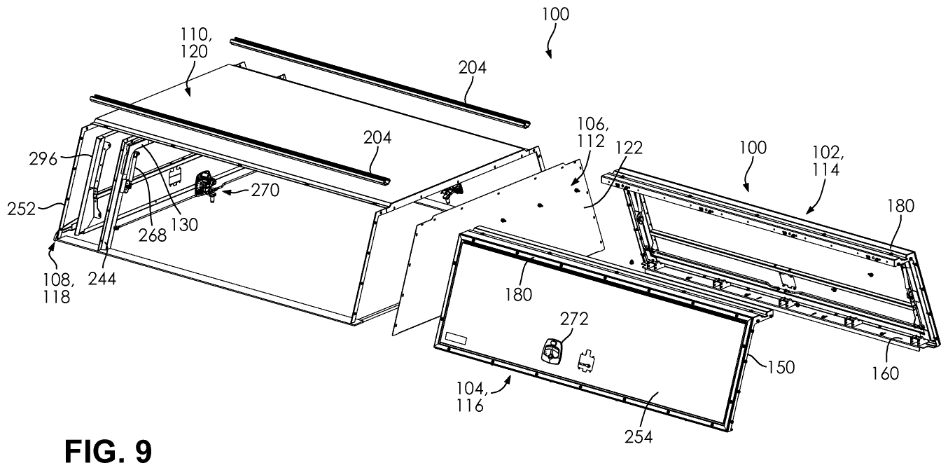

The sub-frame may also be comprised of a front side bracket 150, as shown in FIGS. 9, 10 and 11. The front side bracket 150 may be sized and shaped similarly, if not the same as, the rear side bracket 130 that is located on the same side of the cap 100. As such, the front side bracket 150 may have a side section 152, an upper flange 154, a first side portion flange 156 and a second side portion flange 158. For example, the rear and front side brackets 130, 150 on a driver side of the cap 100 may be the same as one another and the front and rear side brackets 130, 150 on a passenger side of the cap 100 may be the same as one another. Thus, in the installed condition, the side portions 132, 152 and the upper flanges 134, 154 of the brackets 130, 150 on a selected side of the cap 100 may extend generally parallel and coplanar one another, respectively. In such a case, the second flange 148 of the rear side bracket 130 may extend toward the second flange 150 of the front side bracket 150.

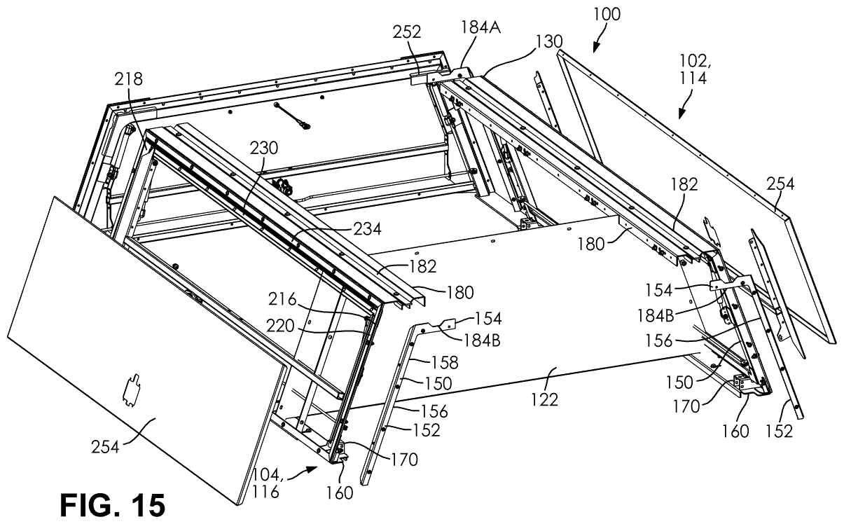

On each side of the cap 100, the front side bracket 150 and the rear side bracket 130 may be connected to one another through a sill 160 as may be appreciated from FIGS. 14 and 15. The sill 160 may also be part of the sub-frame of a module, such as a side module 114, 116. The sill 160 may extend between the side portions 132, 152 of each of the brackets 130, 150, such as at lower end portions 144, 162 of the brackets 130, 150. The connection between the lower end portions 144, 162 of the brackets 130, 150 and the sill 160 may be a direct connection without any intervening structures. Mechanical fasteners may be used to connect the brackets 130, 150 with the sill 160.

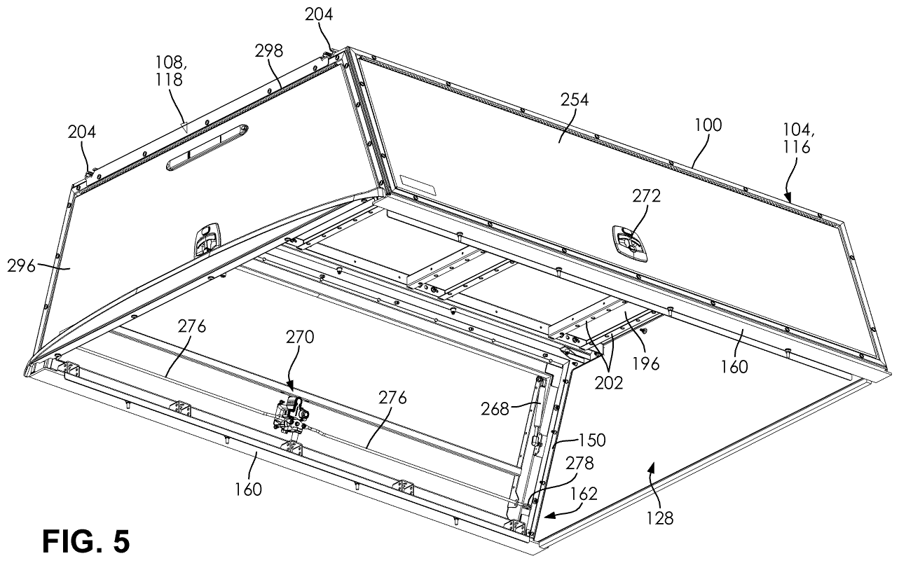

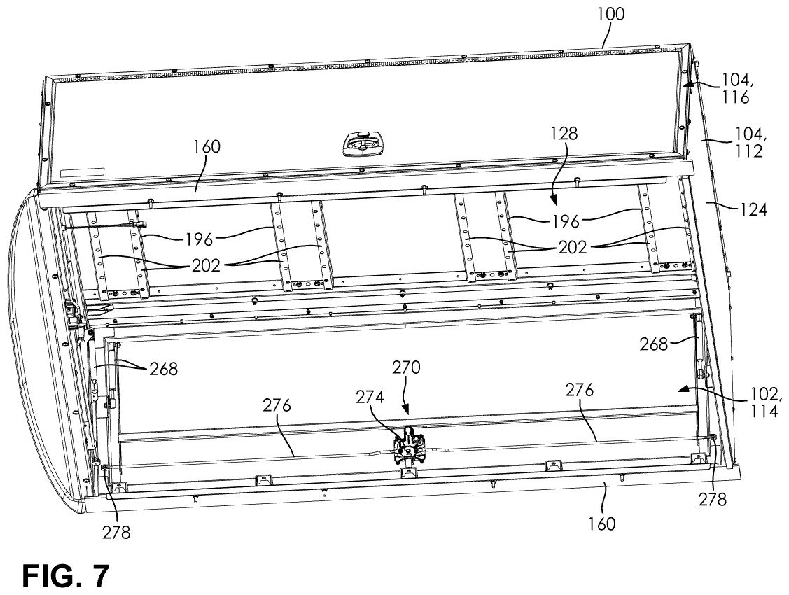

The sill 160 may be a length of material with its largest dimension in the longitudinal direction. In some cases, the sill 160 may terminate adjacent the lower end portion 144, 162 of the brackets 130, 150 (see for example FIGS. 5 and 7). The sill 160 may have a lateral dimension as well to provide the sill 160 with a generally rectangular shape.

The sill 160 may have a central portion 164 that is generally planar. As used here and later, the terms “general” or “substantially” may include standard manufacturing tolerances. The central portion 164 may be generally bounded by an inner wall 166 and an outer wall 168. The inner wall 166 may extend generally in a downward direction along the Y-axis and the outer wall 168 may extend generally in an upward direction along the Y-axis. In such a configuration, the sill 160 may have a general S-shaped cross-section.

In some cases, anchor portions 170 may be connected to the sill 160. In one embodiment, at least one anchor portion 170 may be connected to an upper surface 172 of the central portion 164. It may be that a plurality of anchor portions 170 that are generally equally spaced from one another may extend along the upper surface 172.

The anchor portions 170 may be comprised of two uprights 174 extending upwardly in the Y-direction from the upper surface 172. The uprights 174 may be generally parallel one another. The uprights 174 may be connected together by a top 176. The sill 160 may function to close the bottom of the anchor portion 170 to provide a box shaped anchor portion 170. The anchor portions 170 on one sill 160 may be generally aligned with anchor portions 170 on the opposite sill 160 along both the X and Y directions.

In some instances, a bottom surface 178 of the central portion 164 may be in direct contact with an upper surface of a side wall of a vehicle pick up truck. Mechanical fasteners may extend through the sill 160 into the side wall of the vehicle to secure them together. It may be however that the sill 160 and the cap 100 can also be connected together with clamps, stakes, couplers or the like.

A roof side member 180 may connect the upper flanges 134, 154 of the rear and front side brackets 130, 150 on each side of the cap 100. The roof side member 180 may be part of the sub-frame. The embodiment depicted in FIG. 15 demonstrates how the upper flanges 154 of the front side brackets 150 may have a complementary profile to the roof side member 180 to facilitate the connection. For example, the upper flanges 154 and the roof side member 180 may have a general M shaped cross-section. The roof side member 180 may have a central groove 182 that may extend the length of the member 180 in a continuous, uninterrupted fashion. The rear and front side brackets 130, 150 may have a complementary shaped groove 184 A, B in their upper flanges 134, 154.

The top portion 110 may comprise a roof member 186 as best seen in FIGS. 1-4 and 9-10. The roof member 186 may be such as a sheet of metal that has a generally planar central section 188. The central section 186 may be bounded by two edge portions 190. The edge portions 190 may extend downwardly from the central section 186 and may at least partially nest within the central groove 182.

The central section 188 may be substantially planar in its extension along the X-direction. The roof member 186 may have an upper side 192 and a lower side 194 defining a substantially constant thickness between them. The roof member 186 may enclose the cap 100.

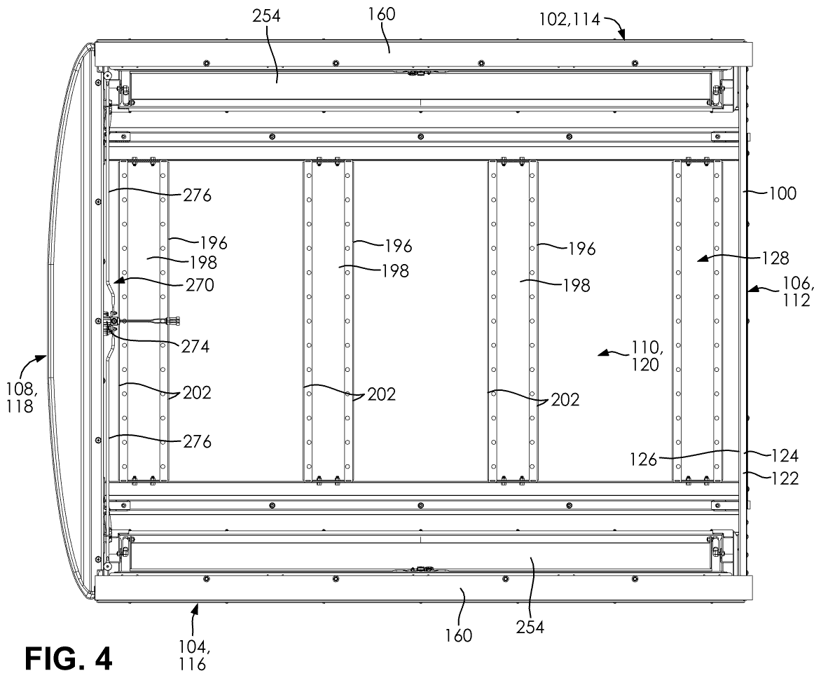

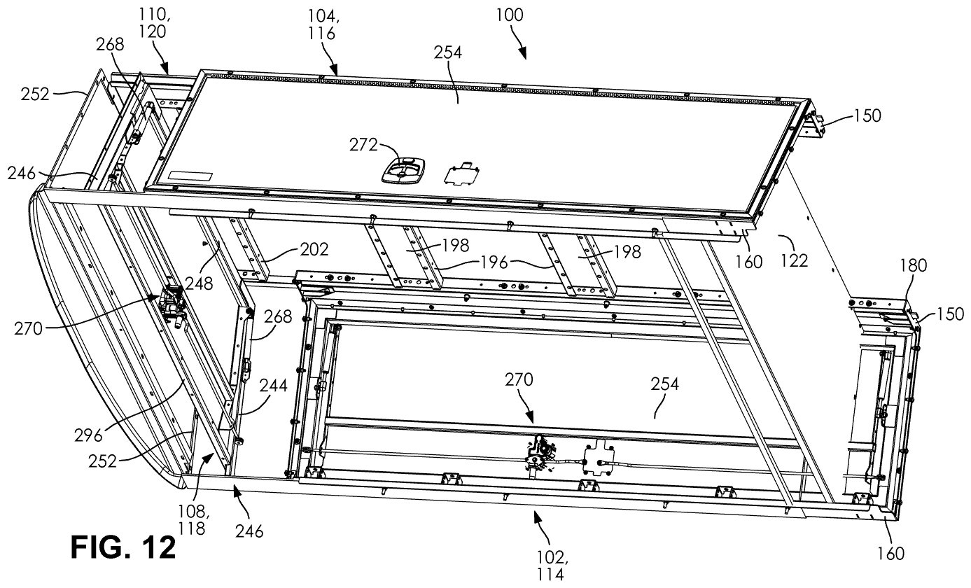

One or more roof supports 196 may be located on the lower side 194 of the roof member 186. One embodiment of the supports 196 may be seen in FIGS. 4, 6, 7, 8, 11 and 12. In some cases, there may be a plurality of supports 196 that extend across the roof member 186 in the Z direction. The supports 196 may be equally spaced from one another. And, in some cases, the supports 196 may be sized and shaped approximately the same as one another.

The supports 196 may each have a central member 198. An upper side 200 of each central member 198 may be in direct facing contact with the lower side 194 of the roof member 186. Side flanges 202 may depend from the central member 198 and the side flanges 202 may extend substantially transverse the central member 198 such as in the Y direction. Side flanges 202 on an outboard side of the supports 196 may be connected to the adjacent roof side member 180. The connection may be such as through mechanical fasteners.

The supports 196 may provide rigidity and structure to the roof member 186. In addition, the side flanges 202 may provide wire ways and/or apertures to hang equipment and/or supplies.

In some cases, a rail 204 may be located at least partially in at least the central groove 182 of each roof side member 180 and the edge portions 190 of the roof member 186, as shown in FIGS. 1, 2 and 3. The rail 204 may have a lower portion 206 with a complementary profile to the central groove 182 and the roof member 186. The rail 204 may have two side portions 208 that are connected together by the lower portion 206 and may assist in forming the lower portion 206. The side portions 208 may also have a complementary shape to the central groove 182 and the roof member 186. The shape and size of the rail 204 may assist it in at least partially nesting with the central groove 182. An upper portion 210 of the rail 204 may define a slot 212. The slot 212 may extend the length of the rail 204 and provide access to an interior void 214 of the rail 204 defined by the lower and upper portions 206, 210. The rails 204 provide an attachment device or structure such that other structures including roof racks, ladder racks, storage devices and the like can be connected to the cap 100.

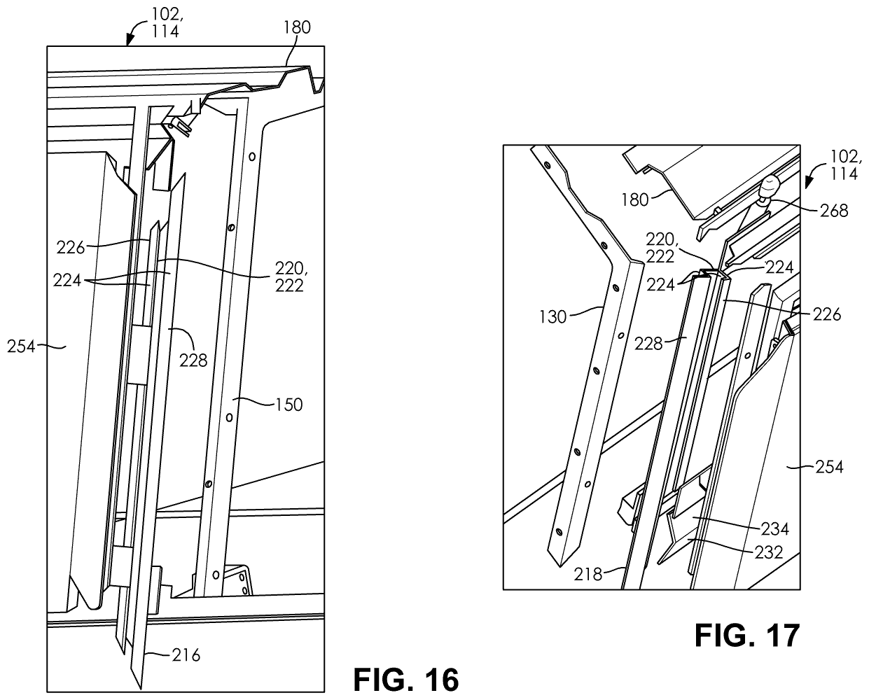

Each first and second side portion 102, 104 may have forward and rear side channel members 216, 218. The side channel members 216, 218 may be part of the respective side modules 114, 116. One embodiment of the first and second side portions 102, 104 is depicted in FIGS. 16 and 17, respectively.

Each of the forward and rear side channel members 216, 218 may have a central channel 220. The central channels 220 may be continuous and generally linear; they may have a substantially constant profile along their extension. The forward and rear side channel members 216, 218 generally extend parallel one another in the Y-direction. As such, the central channels 220 also run parallel one another in the Y-direction.

Each central channel 220 may be comprised of a base 222 extending between upstanding side walls 224. A side wall 224 of each of the channel members 216, 218 may be directly connected to a side portion 132, 156 of one of the rear or front side brackets 130, 150 through mechanical fasteners.

In some embodiments, a first extending wall 226 may extend from at least one of the side walls 224 of each of the channel members 216, 218. The first extending wall 226 may at least partially overlap with the base 222. The first extending wall 226 may be parallel but be spaced apart from the base 222. The first extending wall 226 may extend for the length of the base 222, or only a portion thereof.

A second extending wall 228 may extend from the other side wall 224 of each of the channel members 216, 218. The second extending wall 228 may extend outwardly from the side wall 224 such that it does not overlap the base 224.

Each forward and rear side channel member 216, 218 may be connected to upper and lower channel members 230, 232. In addition, the lower channel member 232 may be connected to the sill 160. The upper channel member 230 may be connected to the roof side member 180.

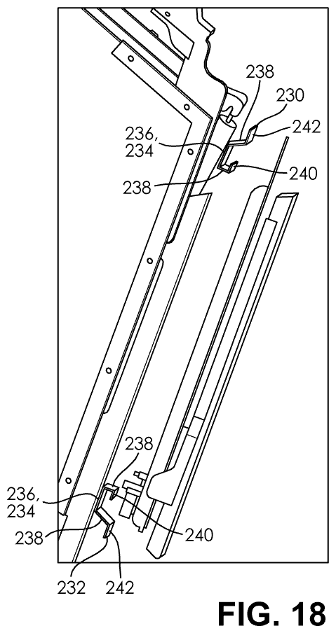

One embodiment of the upper and lower channels members 230, 232 is depicted in FIG. 18. Each upper and lower channel member 230, 232 may have a central channel 234. The central channels 234 may be continuous and generally linear. The central channels 234 may have a substantially constant profile along their extension. The upper and lower channel members 230, 232 both generally run parallel one another along the X-direction. As such, the central channels 234 also run parallel one another in the X-direction.

Each central channel 234 may be comprised of a base 236 extending between upstanding side walls 238. In some embodiments, a first extending wall 240 may extend from at least one of the side walls 238 of each of the channel members 230, 232. The first extending wall 240 may at least partially overlap with the base 236. The first extending wall 240 may be parallel but be spaced apart from the base 236. The first extending wall 240 may extend for the length of the base 236, or only a portion thereof.

A second extending wall 242 may extend from the other side wall 238 of each of the channel members 230, 232. The second extending wall 242 may extend outwardly from the side wall 238 such that it does not overlap the base 236.

The channels 220, 234 of the forward and rear side frame members 216, 218 and the upper and lower channel members 230, 232 may connect with one another to provide a continuous channel. The channels 220, 234 of the frame members 216, 218, 230, 232 may have substantially the same size and shape as one another. The continuous nature of the channels may permit liquid, such as precipitation, to freely flow through the channels 230, 234 in the frame members 216, 218, 230, 232. The orientation of the frame members 216, 218, 230, 232 may result in a continuous channel 220, 234 having a generally rectangular path. Drain holes may be located in the channel 220, 234 to expel the water from the channel 220, 234.

The first extending walls 226, 240 of the forward and rear side frame members 216, 218 and of the upper and lower frame members 230, 232 at least partially enclose the channels 220, 234 they overlap. The overlapping nature of the first extending walls 226, 240 may assist in at least partially deflecting water from the channels 220, 234 so that they do not become overwhelmed. In addition, the overlapping nature of the first exterior walls 226, 240 may provide a more continuous and thus finished appearance to the side portions 102, 104.

The channels 220, 234 may also provide a receptacle for doors of the cap 100. Turning to FIGS. 10, 11, 12 and 19-21 one embodiment of a rear arch member 244 is depicted. The rear arch member 244 may be comprised of two angled side legs 246 that are connected together by a center section 248. The center section 248 may extend parallel to the roof member 186. The rear arch member 244 may be one piece, unitary and integrally formed, or it may be comprised of a plurality of pieces.

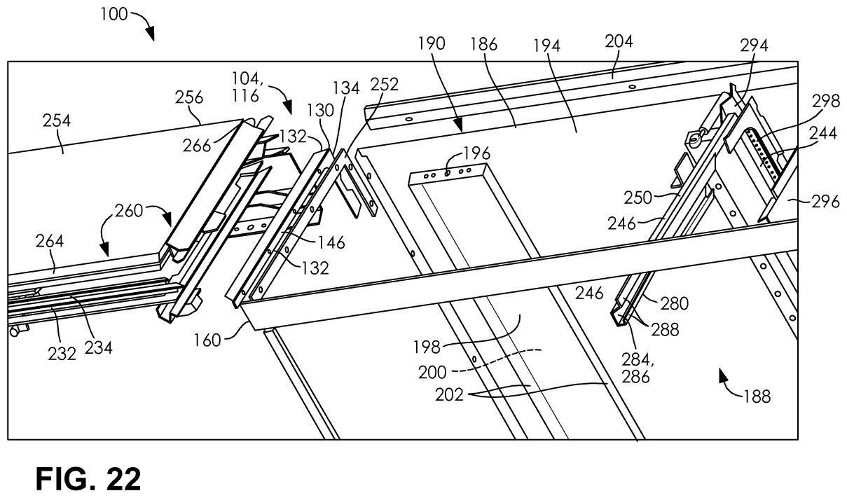

The legs 246 may extend parallel and/or be coplanar with the side portions 132 of the rear side brackets 130, which may be appreciated from FIG. 22. The legs 246 may have a complementary shape, size and angle to the side portions 132 of the rear side brackets 130. In some cases, an inside surface 250 of the legs 246 may be directly attached to the first flanges 146 of the side portions 132. The attachment may be through mechanical fasteners. The rear arch member 244 may provide support for the roof member 186, as well as a connection point for a hinge to support a rear door.

The rear arch member 244 may be part of the sub-frame and the rear module 118. Like the other sub-frame members, the rear arch member 244 may be constructed of metal, but other robust materials capable withstanding an outdoors, over-the-road environment may be used.

Opposite the rear arch member 244, the front panel 122 may function to close a front portion 106 of the cap 100. As such, the panel 122 may extend between the front side brackets 150. In some cases, the panel 122 may be connected to the front side brackets 150. Gaskets 252, having a complementary shape to the front side brackets 150, may be located between the front side brackets 150 and the front panel 122 to provide a weatherproof seal. Similarly, gaskets 252 of the same side and shape may be located on the rear side brackets 130, as shown in FIGS. 10 and 22.

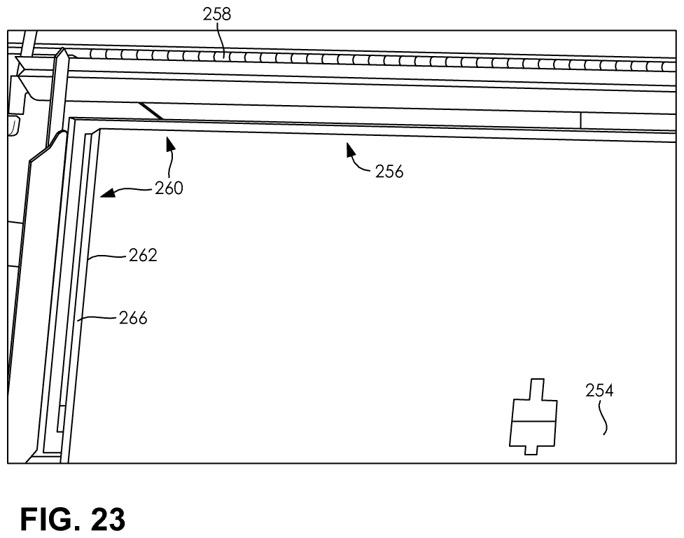

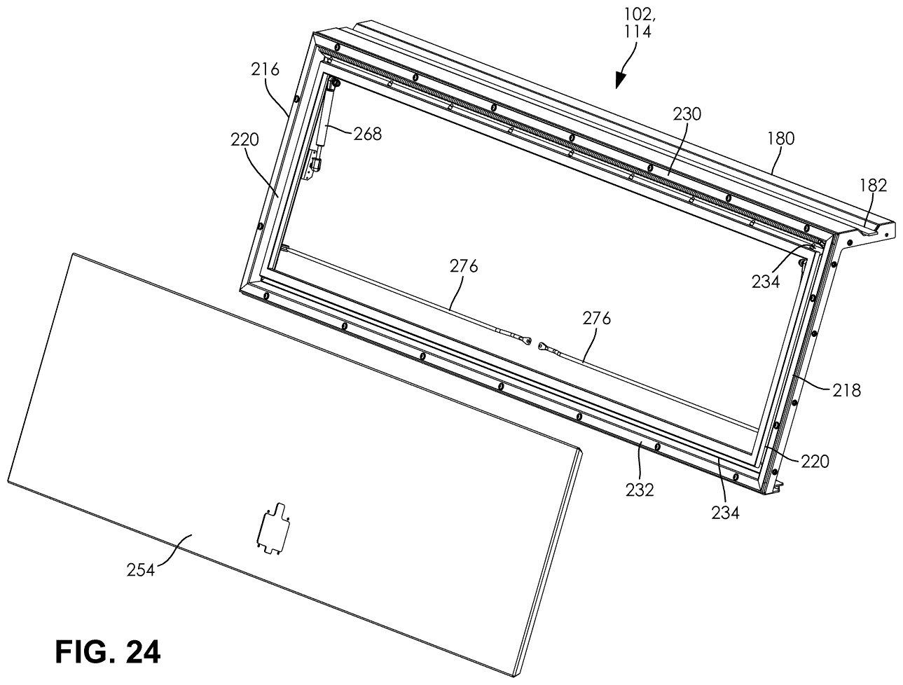

The first and second side portions 102, 104 may comprise door panels 254 which may be appreciated from at least FIGS. 1-12. The door panels 254 may be substantially the same as one another in size, shape and construction. In one embodiment, the door panels 254 may be constructed of sheet metal. The door panels 254 may be movably mounted such that they can pivot between an open condition, a closed condition and anywhere in between. In one case, an upper edge portion 256 of each door panel 254 may be connected to the respective roof side member 180, such as through a hinge 258 as shown in FIG. 23. The hinge 258 may be a piano hinge that may substantially extend the length of the upper edge portion 256.

Each door panel 254 may have a perimeter edge portion 260. The perimeter edge portion 260 may be comprised of at least two sides 262, a lower perimeter edge portion 264 and the upper edge portion 256. The side and lower perimeter edge portions 262, 264 may have flanges 266 which may be seen in FIG. 14. The flanges 266 may generally extend transverse the plane of the panel 254. The transverse direction may be such as in the Z direction when the panel 254 is in a closed orientation.

At least the side and lower edge portions 262, 264 may selectively fit in the channels 220, 234 of the front and rear side channel members 216, 218 and the upper and lower channel members 230, 232. In some cases, the edge portions 262, 264 may function to close the channels 220, 234 such that water and/or debris cannot enter the channels 220, 234 from outside the panels 254. Further, locating the edge portions 262, 264 in the channels 220, 234 provides a seamless appearance for the cap 100. The upper edge portion 256 of the panel 254 and its hinge 258 may be located in the channel 234 of the upper channel member 230.

Biasing members 268 may be connected between the door panels 254 and the sub-frame members. In one instance, the members 268 may be comprised of fluid filled cylinders with biasing pistons and piston rods extending therefrom. The piston rods may be connected to the door panels 254 and the cylinders may be connected to the front or rear side brackets 150, 130 or the side channel members 216, 218 as may be appreciated from FIGS. 5, 6, 7 and 8. The biasing members 268 can provide an assistive force to raise the door panels 254 or to softly lower them.

Each of the door panels 254 may be provided with a latching system 270 which may be seen in FIGS. 1, 2, 5, 6 and 7. The system 270 may be comprised of an exterior actuator, such as a handle 272. An extension 274 is located from the actuator 272 through the panel 254. Two rods 276 may be connected to the extension 274. The rods 276 may generally extend the length of the panel 256 they are associated with. The rods 276 may selectively engage with apertures 278 in the sub-frame members, such as the front or rear side brackets 150, 130 or the side channel members 216, 218. When the rods 276 are located in the apertures 278, the panel 254 is locked thereto and the panel 254 will not open. The exterior actuator 272 can be rotated, which pulls the rods 276 out of the apertures 278 and permits the panels 254 to be opened.

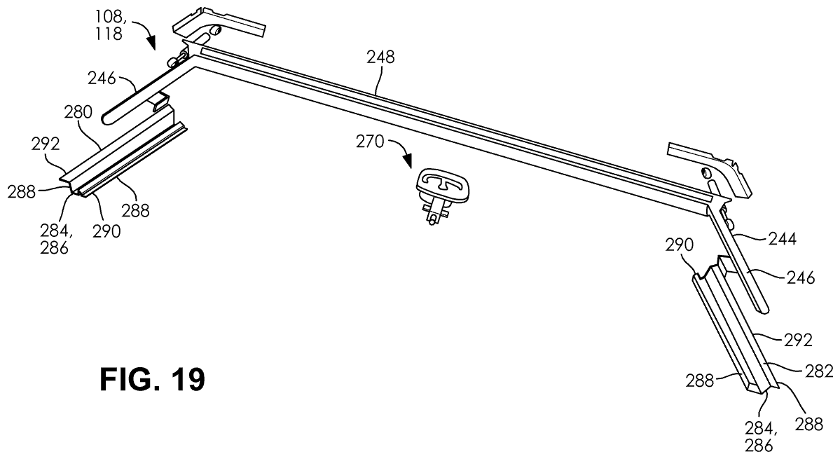

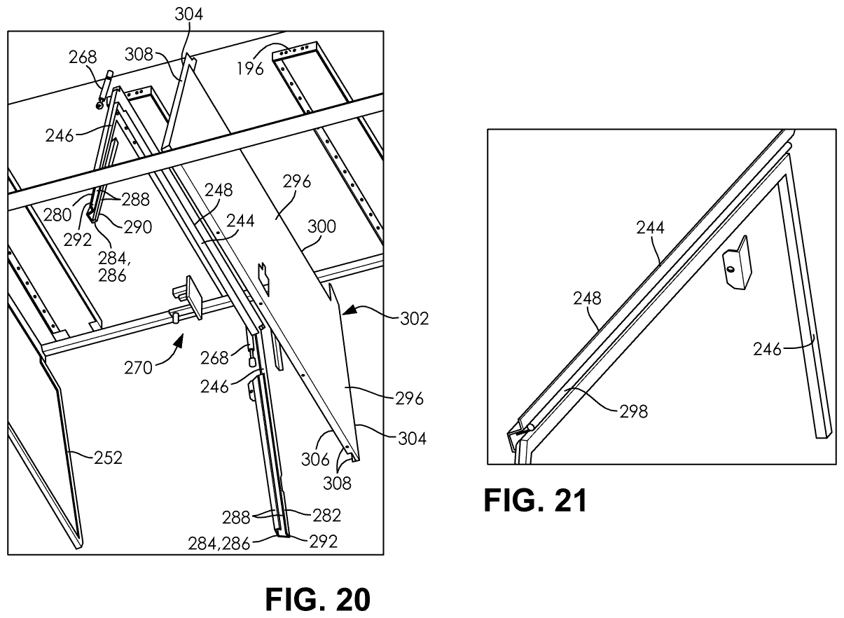

The rear module 118 may also be comprised of first and second rear end channel members 280, 282. One embodiment of the first and second rear end channel members 280, 282 may be seen in FIGS. 19 and 20. The first and second rear end channel members 280, 282 may be part of the sub-frame.

Each of the first and second rear end channel members 280, 282 may have a central channel 284. The central channels 284 may be continuous and generally linear. The channel members 280, 282 generally extend parallel one another in the Y-direction and may be coplanar with one another in the X-direction.

Each central channel 284 may be comprised of a base 286 extending between upstanding side walls 288. A side wall 288 of each of the channel members 280, 282 may be directly connected to a side leg 246 of the rear arch member 246 through mechanical fasteners, as shown in FIG. 20.

In some embodiments, a first extending wall 290 may extend from at least one of the side walls 288 of each of the channel members 280, 282. The first extending wall 290 may at least partially overlap with the base 286 as shown in FIGS. 19 and 20. The first extending wall 290 may be parallel but be spaced apart from the base 286. The first extending wall 290 may extend for the length of the base 286, or only a portion thereof.

A second extending wall 292 may extend from the other side wall 288 of each of the channel members 280, 282. The second extending wall 292 may extend outwardly from the side wall 288 such that it does not overlap the base 286.

As shown in FIG. 22, the second extending side walls 288 may be connected to respective legs 246 of the rear arch member 244. The connection may be such that the second extending side walls 288 at least partially overlap a respective leg 246. As noted above, a gasket 252, may be located between the second extending side walls 292 and a leg 246 and/or the rear side brackets 130. The second extending side walls 292 may be mechanically fastened to the respective legs 246 of the rear arch member 244.

FIG. 22 also depicts the condition where a rear end channel member 280 or 282 is located on the opposite side of a rear side bracket 130 from a rear side channel member 218. More particularly, the second extending wall 292 may be attached to the leg 246 of the rear arch member 244. A gasket 252 may be located between the leg 246 and the side portion 132 of the rear side bracket 130. And the rear end channel member 280 or 282 may be attached to the side portion 132 of the rear side bracket 130.

As may be seen in FIG. 21, the center section 248 of the rear arch member 244 may define a channel 294. The channel 294 may extend substantially continuously and with a substantially constant profile across the center section 248. The channel 294 of the center section 248 may be substantially the same in size and shape as the channels 284 of the first and second rear end channel members 280, 282.

The channel 294 of the center section 248 may be connected to the channels 284 of the first and second rear end channel members 280, 282 to provide a continuous channel 284, 294. The continuous nature of the channel 284, 294 may permit liquid, such as precipitation, to freely flow through the channel 284, 294. Drain holes may be located in the channel 284, 294 to expel the water from the channel 284, 294.

The first extending walls 290 of the first and second rear end channel members 280, 282 may at least partially enclose the channels 284 they overlap. The overlapping nature of the walls 290 may assist in at least partially deflecting water from entering the channels 284 so that they do not become overwhelmed. In addition, the overlapping nature of the walls 290 may provide a more continuous and thus finished appearance to the rear portion 108. The channels 284 may also provide a receptacle for a rear door panel 296 of the cap 100.

The channel 294 of the rear arch member 244 may also contain at least part of a hinge 298, such as a piano hinge, that may extend substantially along the length of the channel 294. A first portion of the hinge 298 may be located in, or adjacent, the channel 294 and connected thereto with mechanical fasteners. A second portion of the hinge 298 may be connected to the rear door panel 296.

The rear door panel 296 may be of similar construction and operation to the side doors panels 254. One embodiment of the rear module 118 and rear door panel 296 may be seen in FIGS. 1, 5, 6, and 8-11. The rear door panel 296 may be movably mounted such that it can pivot between an open condition, a closed condition and anywhere in between. In one case, an upper edge 300 of the rear door panel 296 may be hingedly connected to the center section 248 of the rear arch member 244 as noted above.

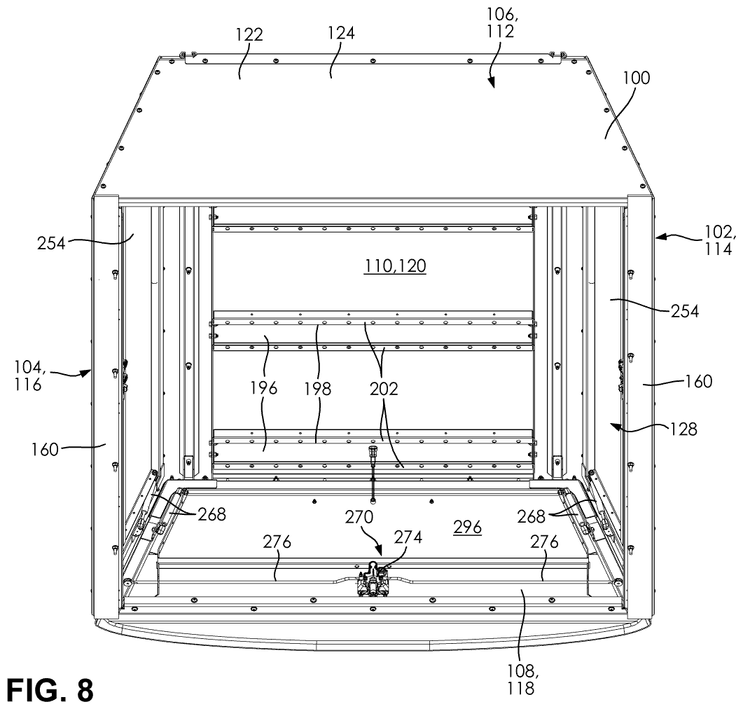

As may be appreciated from figures such as FIGS. 8, 9, 10, 11, 12, 19 and 20 the rear door panel 296 may have a perimeter edge portion 302. The perimeter edge portion 302 may be comprised of at least two sides 304, a lower perimeter edge portion 306 and the above-noted upper edge portion 300. At least the sides and lower perimeter edge portions 304, 306 may have flanges 308. The flanges 308 may generally extend transverse the plane of the panel 296. The transverse direction may be such as in the X direction when the panel 296 is in a closed orientation.

At least the sides and lower perimeter edge portions 304, 306 may selectively fit in the channels 284 of the first and second rear end channel members 280, 282. In some cases, the edge portions 304, 306 may function to close the channels 284 such that water and/or debris cannot enter the channels 284 from outside the panels 296. Further, locating the edge portions 304, 306 in the channels 284 provides a seamless appearance for the cap 100.

Biasing members 266, such as those used for the side door panel 254, may be connected between the door panel 296 and the sub-frame members. In one instance, the members 268 may be comprised of fluid filled cylinders with biasing pistons and piston rods extending therefrom. The piston rods may be connected to the door panel 296 and the cylinders may be connected to the channel members or the rear arch member 244. The biasing members 266 can provide an assistive force to raise the door panel 296 or to softly lower them.

The door panel 296 may be provided with a latching system 270, such as that used with the side door panels 254. The system may be comprised of an exterior actuator, such as a handle 272. An extension 274 is located from the actuator 272 through the panel 296. Two rods 276 may be connected to the extension 274. The rods 276 may generally extend the length of the panel 296. The rods 276 may selectively engage with apertures 278 in the sub-frame members, such as the channel members 280, 282 or the rear arch member 244. When the rods 276 are located in the apertures 276, the panel 296 is locked thereto and the panel 296 will not open. The exterior actuator 272 can be rotated, which pulls the rods 276 out of the apertures 276 and permits the panel 296 to be opened.

In accordance with the provisions of the patent statutes, the device has been described in what is considered to represent its preferred embodiments. However, it should be noted that the device can be practiced otherwise than as specifically illustrated and described without departing from its spirit or scope.

What is claimed is:

1. A truck cap, comprising:
a sub-frame, comprising:
a front side bracket and a rear side bracket, wherein each of said brackets has an angled upright portion and an upper flange attached to an upper end portion of the upright portion; and
a sill extending between the brackets,
a side module connected to the sub-frame, the side module comprising:
a forward side channel member, a rear side channel member, an upper channel member and a lower channel member, wherein each of said channel members define a continuous channel extending about the side module,
wherein the channel is bounded by a first wall and a second wall wherein a portion of the first wall is cantilevered over the channel.

2. The truck cap of claim 1, wherein each side bracket is one piece, unitary and integrally formed.

3. The truck cap of claim 1, wherein an obtuse angle is located between the angled upright portion and an upper flange for both brackets.

4. The truck cap of claim 1, wherein the angled uprights extend coplanar one another and the upper flanges are coplanar one another.

5. The truck cap of claim 1, wherein each side bracket has first and second transverse flanges.

6. The truck cap of claim 1, wherein the front side bracket and the rear side bracket are the same size and shape as one another.

7. The truck cap of claim 1, wherein the sill connects the angled uprights portions of the side brackets.

8. The truck cap of claim 1, wherein the sill extends transverse the angled uprights.

9. The truck cap of claim 1, wherein the sill comprises a planar central body portion bounded by an inner wall and an outer wall to form an S-shaped cross-section.

10. The truck cap of claim 9, wherein a plurality of box-shaped anchor portions extend upwardly from the central body portion of the sill.

11. The truck cap of claim 1, wherein the channel members, and their respective channels, connect together to form a rectangular shape.

12. The truck cap of claim 1, wherein the side module is located between the brackets.

13. The truck cap of claim 1, wherein the channel has a substantially constant profile about the channel members.

14. The truck cap of claim 1, wherein the channel comprises a base bounded by the first and second walls.

15. The truck cap of claim 14, wherein the first or second walls are connected to one of the front side bracket or the rear side bracket.

16. The truck cap of claim 14, wherein the first wall is parallel the base and the second wall extends non-parallel the base.

17. A truck cap, comprising:
a sub-frame having a front side bracket and a rear side bracket, wherein each of said brackets has an angled upright side portion and an upper flange top portion attached to an end portion of the upright portion;
a side module attached to and located between the front side bracket and the rear side bracket;
a front module located on a forward side of the front side bracket; and
a rear module located on a rear side of the rear side bracket.

18. A truck cap, comprising:
a sub-frame comprising a front side bracket, a rear side bracket, and a roof side member and a sill extending between the front and rear side brackets, and
a side module comprising an upper channel member attached to the roof side member, a forward side channel member attached to the front side bracket, a rear side channel member attached to the rear side bracket, and a lower channel member attached to the sill,
wherein the side module comprises a continuous channel extending through the upper channel member, the forward and rear side channel members and the lower channel member.

19. The truck cap of claim 18, wherein the upper flanges of the front and rear side brackets, and the roof side member have an M-shaped cross section.

20. The truck cap of claim 18, wherein the roof member has a central section bounded by two edge portions, wherein the edge portions at least partially nest with the roof side member.

21. The truck cap of claim 18, wherein a plurality of roof supports are attached to a lower side of the roof member, wherein at least one roof support has a central member bounded by transverse side flanges.

22. A truck cap, comprising:
a frame member comprising a roof portion connected to a side portion,
a side channel member attached to said side portion, wherein the side channel member has a continuous channel therein, and
a rear side channel member attached to said side portion, wherein the rear side channel member has a continuous channel therein,
wherein the frame member is located between the side channel member and the rear side channel member.

23. A truck cap, comprising:
a sub-frame, comprising:
a rear side bracket comprising a roof portion connected to a side portion; and
a rear arch member comprising a center section located between two legs, wherein one of the legs is connected to the rear side bracket;
a side module supported by the rear side bracket, wherein a partially overlapped channel extends about the side module, wherein a side panel door selectively fits in the channel; and
a rear module supported by the rear arch member and extending generally transverse the side module, wherein a partially overlapped channel extends in part about the rear module, wherein a rear panel door selectively fits in the channel.

24. The truck cap of claim 23, wherein the side portion of the rear side bracket extend parallel an adjacent leg of the rear arch member.

25. The truck cap of claim 24, wherein the panel doors each have a perimeter edge portion with a flange extending therefrom, wherein the flange extends into the respective channel.
